(19) United States
(12) Patent Application Publication
(10) Pub. No.: US 2024/0030729 A1
(43) Pub. Date: Jan. 25, 2024

(54) USB conversion charging device

(71) Applicant: Alice Chen Knowles, Del Norte, CO (US)

(72) Inventor: Alice Chen Knowles, Del Norte, CO (US)

(21) Appl. No.: 17/873,126

(22) Filed: Jul. 25, 2022

(51) Int. Cl. H02J 7/00

(52) U.S. Cl. CPC H02J 7/0045; H02J 2207/20

(57) ABSTRACT

A USB conversion charging device for recharging batteries consisting of a USB power input port and, at least, one DC power output port with a power converting circuitry positioned in between the input port and output port; designed to convert USB DC power input voltage and/or current to a different voltage and/or different current DC power output to recharge a battery.

### PRIOR ART

U.S. Patent Documents

| D280,317 | Aug. 27, 1985 | Boyd et al. |
|---|---|---|
| 4,950,868 | Aug. 21, 1990 | Moss et al. |
| D310,203 | Aug. 28, 1990 | Takahashi et al. |
| D331,220 | Nov. 24, 1992 | Tsuchiya |
| 5,547,399 | Aug. 20, 1996 | Naghi et al. |
| 7,319,207 | Jan. 15, 2008 | Campf et al. |
| D573,088 | Jul. 15, 2008 | Castellicci et al. |
| 7,658,625 | Feb. 9, 2010 | Jubelirer et al. |
| 20170013889 | Jan. 19, 2017 | Chen |
| 20190341731 | Nov. 7, 2019 | Barnett et al. |
| 11,271,409 | Mar. 8, 2022 | Sergyeyenko et al. |
| D945,967 | Mar. 15, 2022 | Liao |
| 11,303,067 | Apr. 12, 2022 | Cruise et al. |
| 11,322,957 | May 3, 2022 | Asahara |
| 11,350,491 | May 31, 2022 | Gray et al. |

### BACKGROUND

### Field of the Invention

The present invention relates to a USB conversion charging device, more particularly, a USB conversion charging device that is capable of providing converted DC power from a USB power source to a different voltage and/or a different current DC power output for recharging battery.

### Description of the Related Art

Wearable electronic devices (eg., heated clothing, heated gloves, heated socks, wearable heat and massage belt, and the like) operated with a rechargeable battery that stores direct current (DC) power, whereas the power output of electrical outlets is alternating current (AC) power.

Wearable electronic devices, therefore, require an AC-to-DC power adaptor wall charger, which is commonly known as a power adaptor or a wall charger that connects to the electrical outlet in one end and is connected to the battery power input port through a DC connector in the other end. In U.S. Pat. No. 5,547,399 is one example of such power adaptor.

As described above, since, the wall charger is used to recharge the battery; and since, it is necessary to recharge the battery when a wearable electronic device battery power is running low or out. There has been no other choice to recharge the battery than by providing an AC power adaptor or wall charger, which is bulky and inconvenient; especially, when country specific wall plugs are needed when traveling abroad, as shown in US Patent Documents 20190341731 and/or D945,967.

To maintain portability, convenience, and economical consideration of a wearable electronic device, recently, there has been more demand to enable the wearable electronic device to be recharged by a Universal Serial Bus (USB) power outlet without using an AC power adaptor or a wall charger. These batteries currently cannot be recharged with a USB power outlet because a USB power outlet offers 5 VDC power output, a voltage that is often too high to recharge a single cell lithium battery and the voltage is too low to recharge two cells in series (2S) lithium battery.

The present invention intends to provide a USB conversion charging device that can easily convert the Universal Serial Bus (USB) power input voltage and/or current to a different power output voltage and/or different current with at least one DC output port to recharge the battery of a wearable electronic device so that it is more portable, convenient, and economical.

### SUMMARY OF THE INVENTION

The present invention relates to a USB conversion charging device comprised of a USB power input port and at least one DC output port that can convert the USB input power to a different voltage and/or a different current DC output power to recharge the battery. Furthermore, the USB conversion charging device is comprised of a cable having a USB connector, at least one DC connector at the power output port, and a DC-to-DC power converting circuitry configured to convert the DC power output from a different voltage and/or different current than the USB power input.

It is an object of the invention to provide a portable, convenient and economical battery charging device to recharge batteries that have different voltage and/or different current from the receiving USB power source. This object is achieved with a device for converting electric power from a USB power outlet, for example, a computer, power station, car cigarette lighter USB adaptor, and etc. to recharge a battery, according to claim 1 to claim 5; and according to the embodiments as described in the claims, the device having a power receiving end of the input port for connecting the device to a USB power source and having at least one power output end for connecting the device to the battery. Wherein, the device is comprised of a power converting circuitry to convert the voltage and/or current of a DC power input from a USB power source to a different output voltage and/or current required to recharge a battery.

An advantage of a USB conversion charging device is portability by having the power converting circuitry inside that converts the USB power source to recharge a battery as needed. There is no more need to carry an encumbering AC-to-DC power adaptor or wall charger to recharge the battery; the lightweight USB conversion charging device is able to recharge the battery from any readily available USB power source. Thereby, providing a user portability by saving a lot of space and weight, especially when traveling and/or being outdoors.

Another advantage is the universality and convenience, suggesting that a user no longer needs to bring country specific converter plugs to convert the wall chargers in a different country to recharge their device battery. USB is an international standardized plug type, and a USB power outlet is commonly available internationally.

Yet, another advantage of a USB conversion charging device is the convenience that a user has an option of recharging multiple batteries at the same time. This allows the user to recharge both batteries of their left and right hand heated gloves at the same time, as an example. Additionally, a USB conversion charging device can integrate a smart power feature, which offers a charging status indicator and will shut-off the power feed to output ports that aren't being used, or when the power demand on the USB conversion cable is too high.

An additional advantage of a USB conversion charging device is the arrangement features, as a cost-reduction, in comparison to the amount of material used in manufacturing an AC-to-DC power adaptor or a wall charger.

Since, a USB conversion charging device is not an AC-to-DC power adaptor and does not need any other country specific wall plugs to use when traveling abroad, and the power conversion circuitry within a USB conversion charging device can be made very small and lightweight, such that the device can be easily carried in a pocket. The features of the present invention, a USB conversion charging device offers portability, convenience, and an economical solution to recharge a battery when compared to existing inventions.

### BRIEF DESCRIPTION OF DRAWINGS

The above mentioned and other features and advantages of the presented invention, and the manner of attaining them, will become more apparent and the invention will be better understood by referencing to the following description of embodiments of the invention, taken in conjunction with the accompanied drawings. Corresponding reference numbers indicate corresponding parts throughout several embodiments. The examples set out herein illustrate embodiments of the invention and such examples are not to be construed, as limiting the scope of the invention in any manner and in which:

FIG. 1 illustrates a perspective view of an embodiment of a USB conversion charging device for recharging a battery, according to the present invention.

FIG. 2 is a perspective view of an alternative embodiment of a USB conversion charging device having one additional DC output connector to be able to recharge two batteries at the same time.

FIG. 3 illustrates some alternative embodiments of different parts of a USB conversion charging device with alternative parts.

FIG. 3A illustrates an embodiment, where an alternative first connector USB port may be used.

FIG. 3B depicts another embodiment of an alternative power converting circuitry location, which may be built into the first connector USB port.

FIG. 3C shows yet another embodiment of an alternative proprietary connector for the second end of the DC power output port to recharge the battery.

FIG. 3D shows another alternative embodiment of a USB conversion charging device arrangement with multiple DC output ports, where each output port receives converted DC power from a power conversion circuitry.

FIG. 4 shows examples of power source options available for a USB conversion charging device to recharge a battery.

FIG. 5 illustrates an example of the operating flowchart of a USB conversion charging device according to the presented invention.

### DETAILED DESCRIPTION OF THE INVENTION

New USB conversion charging device for recharging a battery is discussed herein. In describing the invention, it will be understood that a number of combinations of components are disclosed. Each of these have an individual benefit and each can also be made in conjunction with one or more, or in some cases all, of the other disclosed components. Accordingly, for the sake of clarity, this description will refrain from repeating every possible combination of the individual components in an unnecessary fashion. Nevertheless, the specification and claims should be read with the understanding that such combinations are entirely within the scope of the invention and the claims. The present disclosure is to be considered as an example of the invention, and it's not intended to limit the invention to the specific embodiments illustrated by the figures or description below.

In a practical embodiment, the device is a USB conversion charging device and the first connector is a USB connector and the second connector is a DC power connector. Alternatively, the second connector is a proprietary connector. Such a conversion charging device can advantageously recharge a battery through connection to any readily available USB power source. In the preferred embodiments, after receiving power from a USB power outlet, the power converting circuitry converts the input power voltage and/or current to a different output voltage and/or different current to recharge the battery. The present invention will now be described by referencing the appended figures representing the preferred embodiments.

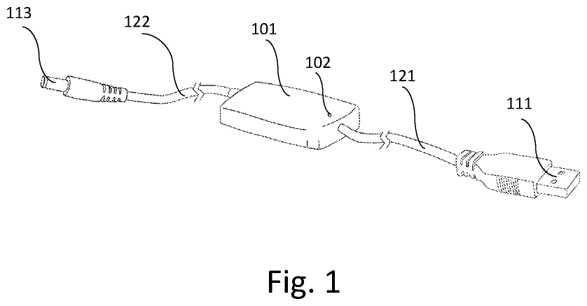

FIG. 1 illustrates a perspective view of an embodiment of a USB conversion charging device for recharging a battery, according to various embodiments of the present invention. In the preferred embodiments, a USB conversion charging device has a first connector 111 at the first end of the cable 121, the first connector being a Universal Serial Bus (USB) connector 111 for plugging into a USB power outlet, for example, a computer or a power station, as the power source. The USB conversion charging device has a second end of the cable 122 at a second connector 113, preferably being a DC power connector or any proprietary connector, as a power output port to recharge the battery.

Furthermore, the device has a power converting circuitry 101 in-between the connectors 111 and 113. The power converting circuitry 101 can integrate smart power features that will shut-off the power feed to output ports that aren't being used or when the power demand on the USB conversion charging device is too high. It also may integrated a battery charging status indicator 102 to indicate the battery charging status. The power converting circuitry 101 may be bound by the first cable 112 and the second cable 122 of various lengths. The DC power inputs from the first connector 111 goes through the power converting circuitry 101, being converted from a USB power source to a different voltage and/or different current and transmitted to the output port 121 to recharge a battery. The cable arrangements 121 and/or 122 may be implemented by a roller, retractable means, or twist to allow people to keep all the cables well stored.

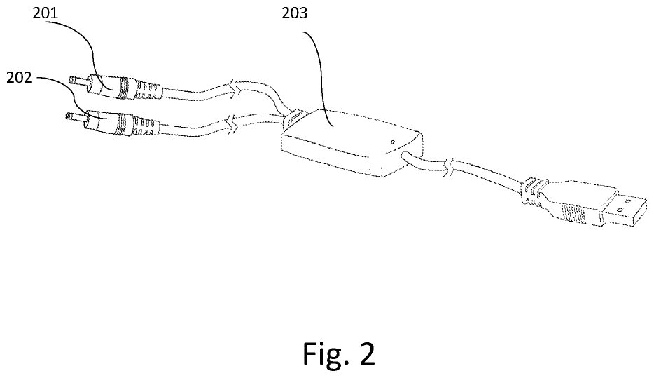

FIG. 2 depicts an alternative embodiment of a USB conversion charging device for recharging a battery having 1) multiple sets of DC power connectors or proprietary connectors 201 and 202 to recharge a second battery 2) power converting circuitry 101 may contain a power distribution circuitry 203 that distributes the input 5 VDC USB power voltage and/or current into multiple sets of different voltage and/or a different current to DC power output ports 201 and 202.

As it shown in FIG. 1 and FIG. 2, the first end 111 is the first connector port of the USB conversion charging device and the second end 113, 201, and 202 are the second connector ports of the USB conversion charging device; wherein, both ends of the USB conversion charging device are fastened directly and irremovable to the power converting circuitry 101 such that the power converting circuitry 101 is being an integral part of the device, and cannot be detached or removed from the USB conversion charging device.

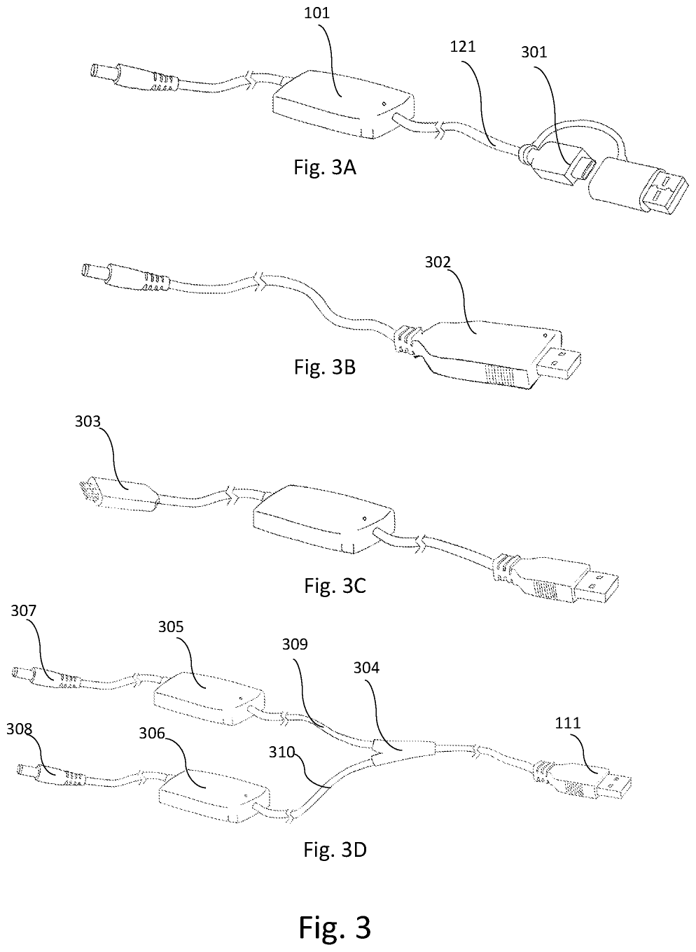

The invention also includes alternative combinations in FIG. 3. In FIGS. 3A, 3B, 3C, and 3D, a USB conversion charging device is shown utilizing different components and has different power converting circuitry location combinations. FIG. 3A illustrates an alternative first cable 121 and its USB-A type connector port 111 may be changed to an interchangeable USB-C type connector 301 for a broader range of USB power outlets.

The power converting circuitry 101 is in an independent PC Board (PCB) as shown in FIG. 1. Alternatively, by relocating the power converting circuitry 101 from an independent PCB so it integrates with the USB connector input 111, the USB connector 302 now contains the power converting circuitry built-in, depicted in FIG. 3B. The power converting circuitry 101 or 302 may also be in a different shape.

The second connector of the charging device is the output port that would be in a different type, size, and shape to fit the receptacle connector of the power receiving battery. FIG. 3C illustrates an example of an alternative connector component 303, which makes up the port of the second connector that plugs into the power receiving battery. In preferred embodiments, the USB conversion charging device is not limited by the described connector 113 in FIG. 1, and may be reconfigured with one or more interchangeable connectors 303 of assorted size, shape and styles to fit the receptacle connector plug of the power receiving battery.

FIG. 3D FIG. 3D shows yet another alternative embodiment of a USB conversion charging device with multiple DC output ports 307 and 308; where each output port receives power from an independent power conversion circuitry 305 and 306, respectively. The power distribution circuitry 304 distributes the USB 5V power input from connector 111 into two 5V power inputs 309 and 310, so each of the power conversion circuitries convert the voltage and/or current into a different voltage and/or current to each DC power output ports 307 and 308 to recharge multiple batteries at the same time.

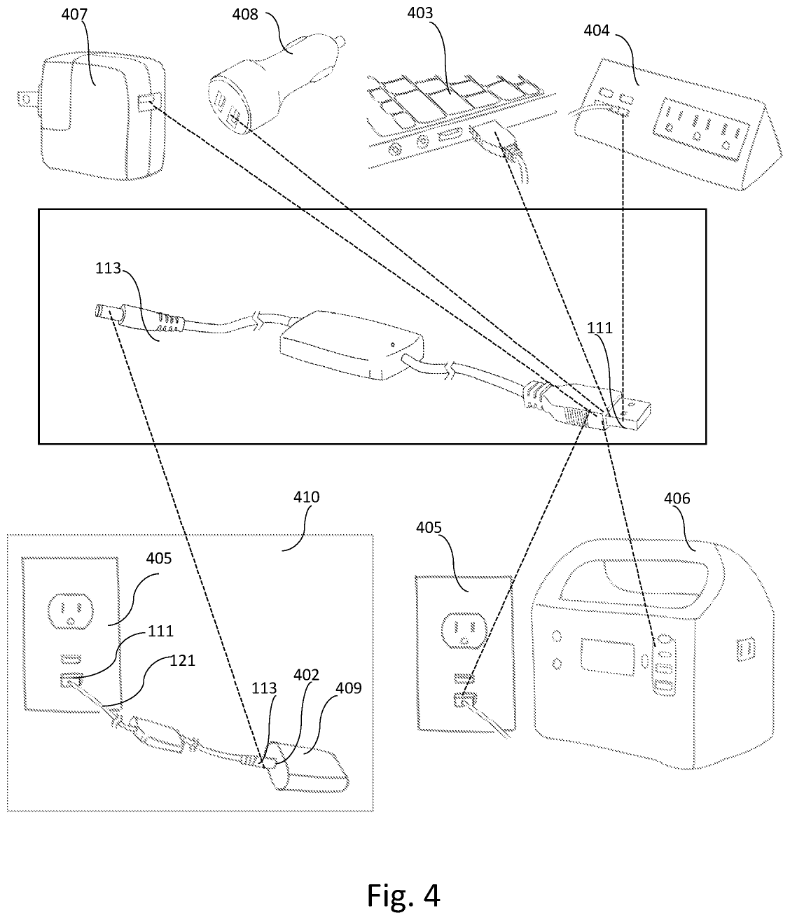

FIG. 4 shows examples of power source options for a USB conversion charging device to recharge a battery and how it connects to recharge a battery. Examples of other optional USB power sources readily available are a USB power outlet through a computer 403, power strip 404, USB wall outlet 405, portable power station 406, USB Charger 407, a car cigarette lighter adapter 408, etc.

Further illustrated in 410 is a USB conversion charging device recharging a battery 409 for use in heated clothing by connecting the first connector USB power input port 111 to the available USB power outlet 405 in one end; and at the other end it connects the power output port 113 to the power receiving port 402 of the battery to recharge the battery 409. As described in the embodiments of FIG. 1, 410 in FIG. 4 illustrates an example of how a USB conversion charging device receives power from the USB input port 401 and converts the input voltage and/or current to a different voltage and/or different current to the output port 113 to recharge a battery 409.

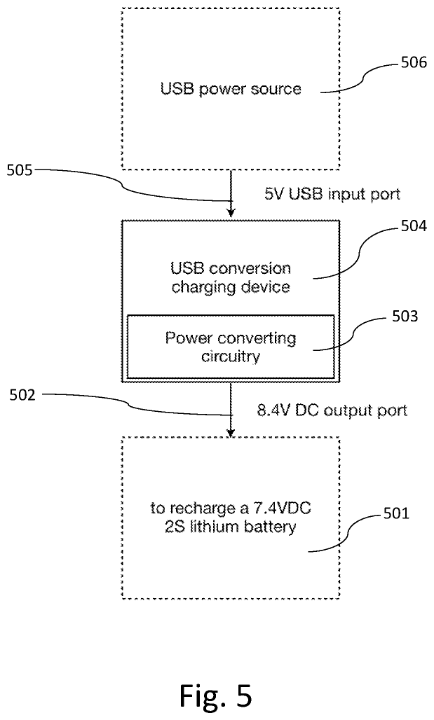

In all the above embodiments, as illustrated in FIG. 5 is an example of the operating flowchart, which shows a 7.4V lithium battery 501 being recharged by a higher voltage 8.4 VDC power output 502 than the 5 VDC USB power 505 provided from a USB power source 506. Whereas, the USB input port 505 receives 5 VDC USB power source 506 to the USB conversion charging device 504, so that the power conversion circuitry 503 within converts the input power to a higher DC power output through the output port 502 to recharge a 7.4 VDC lithium battery 501.

### BEST MODE OF IMPLEMENTATION

Situation 1. Often, a user gets caught unprepared when being outside with minimum carrying capacity; whereby, the wearable electronic device battery is depleted because they have forgotten to recharge the battery or it's discharged from extended usage. In such a situation, they find themselves disconnected and stranded without power to operate the wearable electronic device. Generally, it is hard to find a wall outlet to recharge the battery when a user is outside, for example, camping. It is next to impossible to find somebody else with a similar AC-to-DC power adaptor or wall charger that can be shared to recharge the battery. In the above situation, according to the invention, the user can carry a lightweight USB conversion charging device to recharge their wearable electronic device battery that plugs into a USB power source, such as a portable power station or a lab top computer to recharge their wearable electronic device battery as needed.

Situation 2. A user often misplaces their battery charger. This may result in an extra expense to replace it and a greater environmental impact, as more materials are being used to make them. In the above situation, according to the invention, the user can simply purchase a replacement USB conversion charging device at a lower cost than an AC-to-DC power adaptor or wall charger, so their battery can be recharged by any readily available USB power outlet.

Situation 3. An electronic device supplier always aims to introduce the newest products to the marketplace to increase their market share and gain business. In today's technological world, utilizing USB to recharge a battery has become a trend, so businesses can appear high-tech and environmentally friendly. Wearable electronic device suppliers, whom still include an AC-to-DC power adaptor or a wall charger to recharge their battery devices are being compared to a dinosaur-like technology. In the above situation, according to the present invention, a heated clothing company can now include a USB conversion charging device with their rechargeable battery, so their battery powered wearable heat device instantly becomes the newest technology. A USB conversion charging device resolves the problem of suppliers having to redesign and retool an existing product, so that the battery itself needs to contain a USB input port to receive power from a USB power source.

Although, the present invention has been illustrated and described herein with reference to the preferred embodiments and specific examples; thereof, it will be readily apparent to those of ordinary skill in the art that other embodiments and examples may perform similar functions and/or achieve like results. All such equivalent embodiments and examples are within the spirit and scope of the present invention, and are contemplated; thereby, intended to be covered by the following claims.

1. A USB conversion charging device for recharging a battery from a USB power outlet comprising of a USB power input port, DC-to-DC power converter circuitry to provide converted DC power of a different voltage and/or a different current than the input of the receiving DC power; and, at least one DC power output port to recharge battery.

2. The embodiments as claimed in claim 1, wherein, an alternative first connector USB input port may be interchangeable from USB-A type to USB-C type of connector for a broader range of USB power outlets. The second connector of the device output port may be reconfigured with one or more interchangeable proprietary connectors of assorted size, shape and styles to fit the receptacle connector plug of the power receiving battery. Additionally, the cable arrangements of the charging device may be implemented by a roller, retractable means, or twist to allow people to keep all cables organized and well stored.

3. The embodiments as claimed in claim 1, wherein a power converting circuitry of a USB conversion charging device can integrate smart power features that will shut-off the power feed to output ports that aren't being used or when the power demand on the USB conversion charging device is too high. It also can integrate a battery charging status indicator to indicate the battery device charging status. The power converting circuitry of a USB conversion charging device may be an independent PC Board (PCB) bound by the first cable and second cable of various lengths. Both ends of the USB conversion charging device for recharging a battery are fastened directly and irremovably to the power converting circuitry such that the power converting circuitry, being an integral part of the device, cannot be detached or removed from the USB conversion charging device.

4. The embodiments as claimed in claim 3, wherein, a USB conversion charging device may also contain a different location for the power conversion circuitry, for example integrated with the USB connector input port, so now the power conversion circuitry is part of the first connector USB input port. The power converting circuitry may also be made in conjunction with one or more components, so the enclosure can be in a different shape and size.

5. The embodiments as claimed in claim 1, wherein, a USB conversion charging device for recharging batteries may have an additional DC port for recharging multiple batteries. In this case, the power converting circuitry may contain a power distribution circuitry to distribute the input DC power voltage and/or current into multiple sets of different voltage and/or different current DC power outputs. An alternative assembly is by splitting the input voltage immediately after receiving power from the USB port, then a power conversion circuitry is assigned to convert each of the DC outputs; wherein, each output port has an independent power conversion circuitry that converts DC output.
